(19) United States
(12) Patent Application Publication
(10) Pub. No.: US 2013/0225342 A1
(43) Pub. Date: Aug. 29, 2013

(54) CHAIN TRANSMISSION

(71) Applicant: Tsubakimoto Chain Co.,, (US)

(72) Inventor: Masanori Yokoyama, Osaka (JP)

(73) Assignee: TSUBAKIMOTO CHAIN CO.,, Osaka (JP)

(21) Appl. No.: 13/765,796

(22) Filed: Feb. 13, 2013

(30) Foreign Application Priority Data
Feb. 23, 2012 (JP) 2012-037855

(51) Int. Cl. F16H 7/18

(52) U.S. Cl. CPC F16H 7/18
USPC 474/140

(57) ABSTRACT

A transmission chain is composed of pairs of outer plates and pairs of inner plates. The plates of each pair are in opposed, spaced relation to each other. The pairs of inner plates and the pairs of outer plates are disposed in alternating, overlapping, relationship along the length of the chain, with each pair of inner plates extending in a first direction into a space between one pair of outer plates, and in a second direction, opposite to the first direction, into a space between another pair of outer plates. Connecting pins connect the alternating pairs of plates in articulating relationship. Each of the connecting pins is press-fit into holes in a pair of inner plates and fits rotatably in holes in a pair of outer plates. A guide extends into a space between the outer plates, guiding the chain by engagement with inwardly facing surfaces of the outer plates.

### CROSS REFERENCE TO RELATED APPLICATIONS

The disclosure of Japanese Patent Application No. 2012-037855, filed on Feb. 23, 2012, is here incorporated by reference.

### FIELD OF THE INVENTION

This invention relates to a chain transmission comprising a chain for transmitting power from one or more driving sprockets to one or more driven sprockets, and one or more guides on which the chain slides.

### BACKGROUND OF THE INVENTION

FIGS. 13 and 14 show a prior art chain transmission 500, comprising a roller chain 510 and a chain guide 520 on which the chain slides. Sprockets (not shown) are in driving and driven engagement with the chain. The chain 510 has outer links 513, each composed of a pair of right and left outer link plates 511 and connecting pins 512 press-fit into pin holes 511a of the outer links. The chain also has inner links 516, each composed of a pair of right and left inner link plates 514, and bushings 515 press-fit into bushing holes 514a in the inner link plates 514. The chain 510 is constructed by connecting the inner links 516 with the outer links 513 articulably and in alternating relationship by inserting the connecting pins 512 through the bushings 515 of the inner links 516. A typical prior art chain transmission of this type is disclosed in United States Patent Application publication No. 20070082776, dated Apr. 12, 2007.

As shown in FIG. 15, when a sprocket tooth t presses against a roller 517, pressure transmitted is transmitted to the connecting pin 512 through a roller 517 and a bushing 515. Stress applied to the pin along tends to bend the pin and cause elongation of the chain 510.

Assembly of the roller chain is made difficult by the necessity of applying a high pressure in order to press-fit the end portions 515a of the bushing into the bushing holes 514a in the inner link plates.

As shown in FIG. 14, the chain guide 520 has right and left sidewalls 521 for engagement with the outer sides 511s of the outer link plates. The height of the outer link plates 511 is less than that of the inner link plates 514. Accordingly, the sidewalls 521 need to be high in order to prevent the chain 510 from jumping out of the guide.

When the roller chain 510 is utilized in the timing system of an engine, fluctuation in chain tension can cause the chain to meander within the space between the sidewalls 521, generating sliding contact sounds. The efficiency of the chain transmission is also impaired by excessive friction due to contact between the inner link plates 514 and the chain guide.

Accordingly, there is a need for a chain transmission in which elongation of the chain caused by the defection of the connecting pins is suppressed over a long time; in which assembly of the chain is made easier; in which power can be transmitted more efficiently; and in which meandering of the chain, and jumping of the chain out of sliding engagement with the chain guide or guides, are suppressed without the need to increase the size of the space in which the chain transmission is installed.

### SUMMARY OF THE INVENTION

The chain transmission in accordance with the invention comprises a chain guide and an elongated transmission chain in sliding engagement with the chain guide and arranged to travel along the chain guide in the direction of elongation of the chain. The transmission chain is composed of pairs of right and left outer plates and pairs of right and left inner plates. The plates of each pair of outer plates are in opposed, spaced, relation to each other in the chain width direction, which is perpendicular to the direction of elongation of the chain. The plates of each pair of inner plates are also in opposed, spaced relation to each other in the chain width direction. The pairs of inner plates and the pairs of outer plates are disposed in alternating, overlapping, relationship along the length of the chain. Each pair of inner plates extends in a first direction into a space between one adjacent pair of outer plates, and in a second direction, opposite to the first direction, into a space between another adjacent pair of outer plates. The plates of each pair of outer plates have mutually facing inner surfaces. Connecting pins connect the alternating pairs of plates in articulating relationship. Each of the connecting pins is press-fit into holes in a pair of inner plates and fits rotatably in holes in a pair of outer plates.

Because the connecting pins are press-fit into the inner plates, the portion of each connecting pin that is subjected to bending stress by engagement with a sprocket tooth is shorter than the corresponding portion in a conventional chain by an amount slightly greater than the sum of the thicknesses of the two inner plates. Therefore, it is possible reduce deflection of the connecting pins and to suppress elongation of the chain caused by the deflection of the connecting pins for a long time.

Press-fitting the connecting pins into holes in the inner plates eliminates the need for bushings, resulting in reduction of the number of parts in the chain and also in a reduction of the weight of the chain. Therefore, assembly of the chain is facilitated, and its power transmission efficiency is improved. Elimination of the bushings also makes it possible to reduce the height of the chain, and to reduce the space occupied by the chain in a chain transmission.

According to a second aspect of the invention, the height of the inner plates, measured in a height direction mutually perpendicular to the direction of chain elongation and the chain width direction, is less than the height of the outer plates, also measured in the height direction. The chain guide includes an inner plate-engaging surface facing in the chain height direction and in sliding engagement with edges of inner plates of the chain, and outer plate-engaging surfaces facing in the chain width direction and in facing relationship with inner surfaces of outer plates of the chain for restricting lateral travel of the chain.

With the interposition of the chain guide between the outer plates, the chain is restricted by engagement of the inward-facing surfaces of the outer plates with the outer plate-engaging surfaces of the guide, and meandering of the chain, and jumping of the chain out of engagement with the chain guide, can be more effectively suppressed.

Because the chain guide does not need to be wider than the chain, the size of the chain guide can be reduced, and the space occupied by the guide in a chain transmission can be reduced accordingly. Furthermore, because the range in which the transmission chain can meander is restricted to a distance corresponding to the widths of the small gaps between the inner side surfaces of the outer plates and the outwardly facing, outer plate-engaging surfaces of the guide, it is possible to reduce sliding contact sounds generated by meandering of the chain, and also to reduce frictional losses.

According to a third aspect of the invention, the chain guide can also include a pair of outer plate-engaging surfaces facing in the chain height direction, extending in parallel to the inner plate-engaging surface, and in sliding engagement with edges of outer plates of the chain. In this case it becomes possible to reduce the surface pressure applied by the chain to the chain guide, and thereby reduce wear of the chain guide.

According to a fourth aspect of the invention, the outer plates can be held on the connecting pins by caulked end portions of the connecting pins. Thus, the end portions of a pin can be engaged with opposed outer plates around the entire periphery of the pin. Consequently, the number of parts of the chain, and the overall weight of the chain, can be reduced.

According to a fifth aspect of the invention, the outer plates can be held on the connecting pins by stop rings press-fit onto end portions of the connecting pins. The stop rings can securely prevent the outer plates from becoming disconnected from the connecting pins.

### BRIEF DESCRIPTION OF DRAWINGS

FIG. 1 is a schematic front elevational view of a chain transmission in accordance with the invention;

FIG. 2 is a fragmentary perspective view showing a chain traveling along a chain guide in a transmission according to a first embodiment of the invention;

FIG. 3 is an exploded view of the transmission chain shown in FIG. 2;

FIG. 4 is a side elevational view of the chain and chain guide in FIG. 2;

FIG. 5 is a sectional view of the chain and chain guide taken on section plane V-V in FIG. 4;

FIG. 6 is an elevational view, partly in section, showing the chain of FIGS. 2-5 engaged with a driving sprocket;

FIG. 7 is a fragmentary perspective view showing a chain traveling along a chain guide in a modified transmission of the first embodiment of the invention;

FIG. 8 sectional view of the chain and chain guide taken on section plane VIII-VIII in FIG. 7;

FIG. 9 is a fragmentary perspective view, partly in section, showing a chain traveling along a chain guide in a transmission according to another modification of the first embodiment of the invention

FIG. 10 is a fragmentary perspective view of a chain transmission according to a second embodiment of the invention;

FIG. 11 is a side elevational view of the chain and chain guide in FIG. 10;

FIG. 12 is a sectional view of the chain and chain guide taken on section plane XII-XII in FIG. 11;

FIG. 13 is a side elevational view of a part of a prior art chain transmission;

FIG. 14 is a sectional view taken on section plane XIV-XIV in FIG. 13; and

FIG. 15 is a plan view, partly in section showing the prior art transmission chain in engagement with a sprocket.

### DETAILED DESCRIPTION OF THE PREFERRED EMBODIMENTS

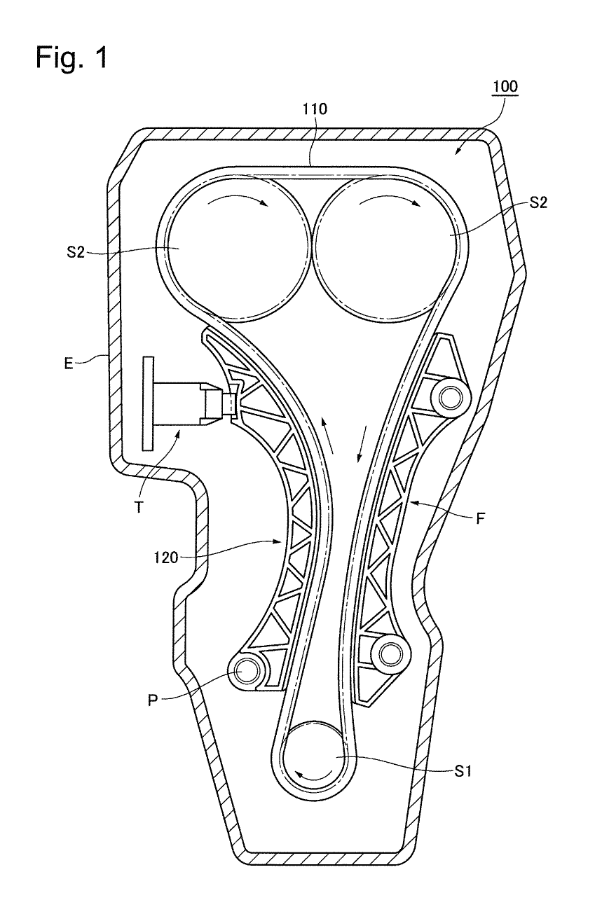

The chain transmission 100 shown in FIG. 1 is a timing chain transmission of an dual overhead valve (DOHC) automobile engine, used to transmit power from the engine crankshaft to a pair of valve-operating camshafts.

The chain transmission 100 comprises a chain 110, a movable guide 120 on which the chain slides in a longitudinal direction, a fixed chain guide F, a chain-driving sprocket S1 on the engine crankshaft (not shown), and two driven sprockets S2 on the engine camshafts (not shown).

The movable guide 120 described above is pivotably mounted on the block of an engine E by a shoulder bolt P, and is urged against the span of the chain that travels from the crankshaft sprocket S1 toward a camshaft sprocket S2 by the plunger of a tensioner T, which maintains proper tension in the transmission chain 110 in order to prevent failure caused by excessive tension or excessive slack in the chain.

The fixed guide F is in sliding engagement with an opposite span of the chain that travels from one of the camshaft sprockets S2 toward the crankshaft sprocket S1.

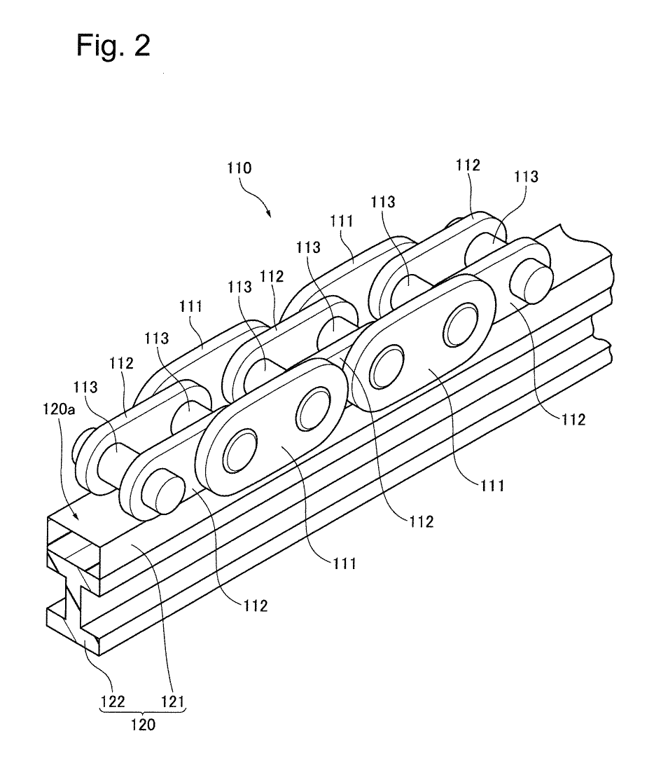

As shown in FIG. 2, The transmission chain 110 has pairs of outer plates 111 in opposed relationship, a right and left outer plate of each pair being spaced from each other in the direction of the width of the chain. The chain also includes pairs of inner plates 112 also in opposed relationship, a right and left inner plate of each pair also being spaced from each other in the direction of the width of the chain. The pairs of outer plates 111 and the pairs of inner plates 112 are disposed in alternating, overlapping relationship, each pair of inner plates 112 extending in a first longitudinal direction into a space between one pair of outer plates 111 and in a second longitudinal direction into a space between another pair of outer plates 111. Connecting pins 113 that extend in the direction of the width of the chain connect the alternating pairs of plates in such a way that the connected pairs of plates can articulate about the axes of the connecting pins.

The movable guide 120 is preferably composed of a polyamide resin shoe 121 on which the chain 110 slides, and a base 122 that supports the back of the shoe 121.

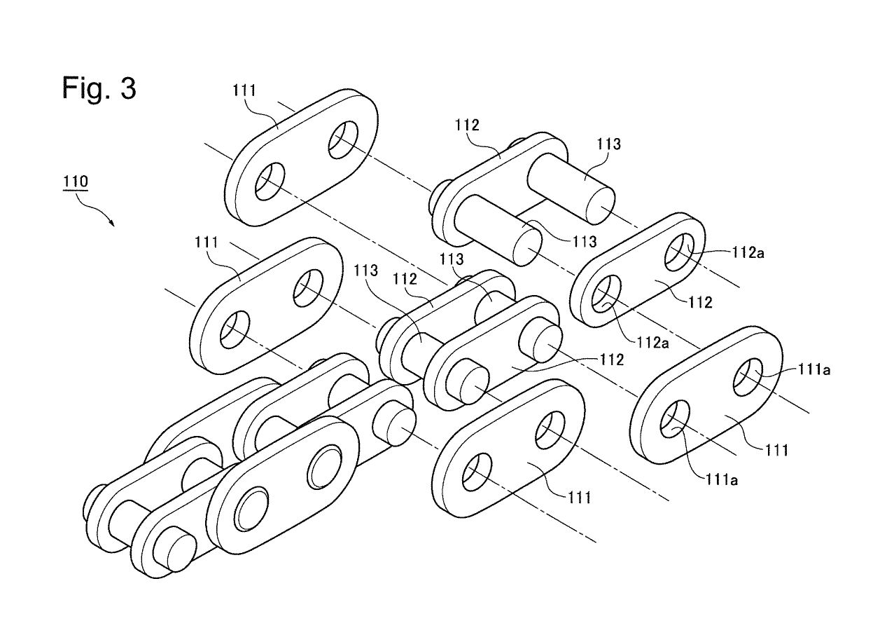

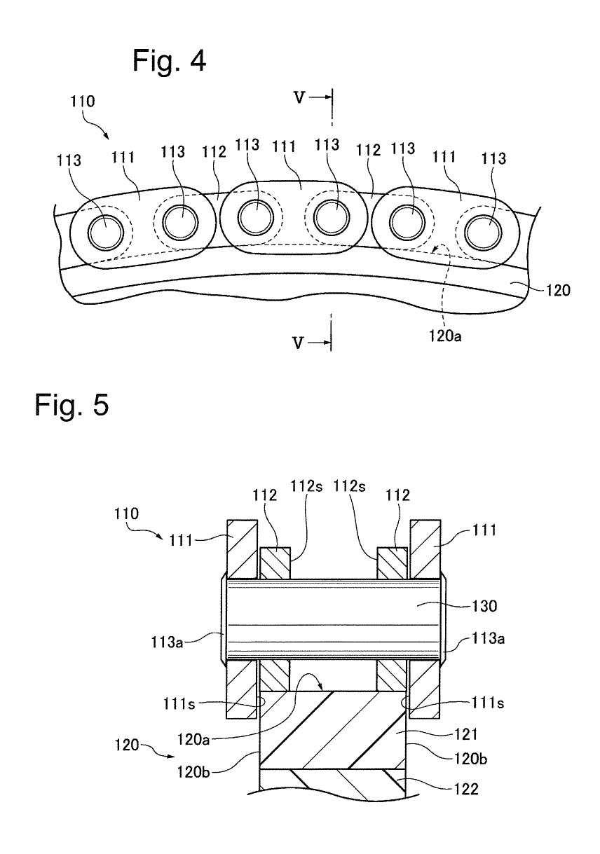

As shown in FIG. 3, the chain 110 is constructed by press-fitting connecting pins 113 into holes 112a in the inner plates 112, and by inserting end portions of the pins 113 into holes 111a in the outer plates 111. The end portions of pins 113 fit closely, but are rotatable in, holes 111a.

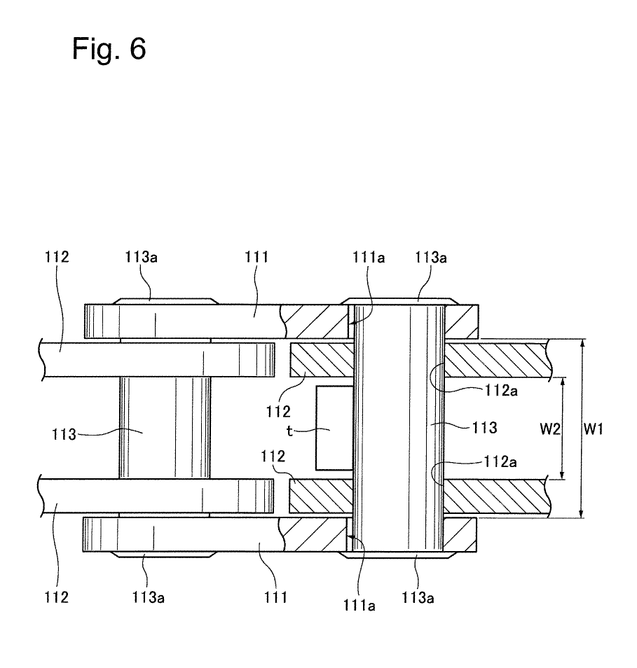

As shown in FIG. 6, the right and left inner plates 112 of each pair of inner plates are separated by a distance W2, which is narrower than the distance W1 between the outer plates 111. Bending stress is applied by a sprocket tooth t to a portion of the length of the pin which is shorter, by a distance slightly greater than the sum of the thicknesses of the two inner plates 112, than a corresponding distance through which bending stress is applied to a connecting pin press fit into a pair of outer plates in a prior art chain.

The chain does not require bushings, and elimination of bushings makes it possible to downsize the outer and inner plates 111 and 112, and to reduce the number of parts and the weight of the chain.

As shown in FIG. 5, the height of the side surfaces 112s of the inner plates 112 is smaller than the height of the side surfaces 111s of the outer plates 111. As shown in FIGS. 2 and 5, the guide 120 has a surface 120a, facing in the direction of the height of the chain, on which the inner plates 112 of the plate slide, and guiding and restricting surfaces 120b, facing in the direction of the width of the chain. Since the guide 120 is interposed between opposed outer plates 111 of the chain, if the chain meanders to either side in the direction of its width, a surface 120b of the guide is contacted by an inner side surface 111s of an outer plate 111. Thus, lateral movement of the chain is restricted by sliding contact between the inner side surfaces ills of the outer plates 111 and the outer surfaces 120b of the guide.

The chain guide of the invention does not require restricting sidewalls arranged on outer sides of a transmission chain, and therefore can be narrower than a conventional chain guide. Furthermore, the range in which the transmission chain 110 can meander can be as small as the distance corresponding to the gaps between the inner side surfaces ills of the outer plates 111 and the surfaces 120b of the guide.

As shown in FIG. 5, the outer plates 111 are prevented from sliding outward beyond the ends of the connecting pins by caulked end portions 113a of the connecting pins 113. As the caulked portions extend around the entire periphery of the end portions of the pins, the outer plates 111 are stopped by the entire periphery of the end portions 113a of the pins. The use of caulking at the end portions reduces the number of parts in the chain, and makes it possible to reduce the weight of the chain for more efficient transmission of power.

Because the connecting pins are press-fit to the inner plates and are rotatable in the outer plates, bending stress is applied only to a relatively small portion of the length of each pin, and elongation of the chain caused by the deflection of connecting pins can be suppressed for a long time.

Because the heights of the inner plates are smaller than the heights of the outer plates, and the guide has both a surface 120a on which the inner plates slide and restricting surfaces 120b for guiding the inner side surface his of the outer plates 111, it is possible to limit meandering of the chain 110 more effectively, and to prevent its jumping from the guide 120. This chain structure also makes it possible to downsize the guide 120 and to reduce the space that it requires.

It is also possible to reduce the sounds generated by sliding contact between the transmission chain and the guide 120 by suppressing meandering of the chain, and to increase the efficiency of power transmission by reducing friction between the chain and the guide.

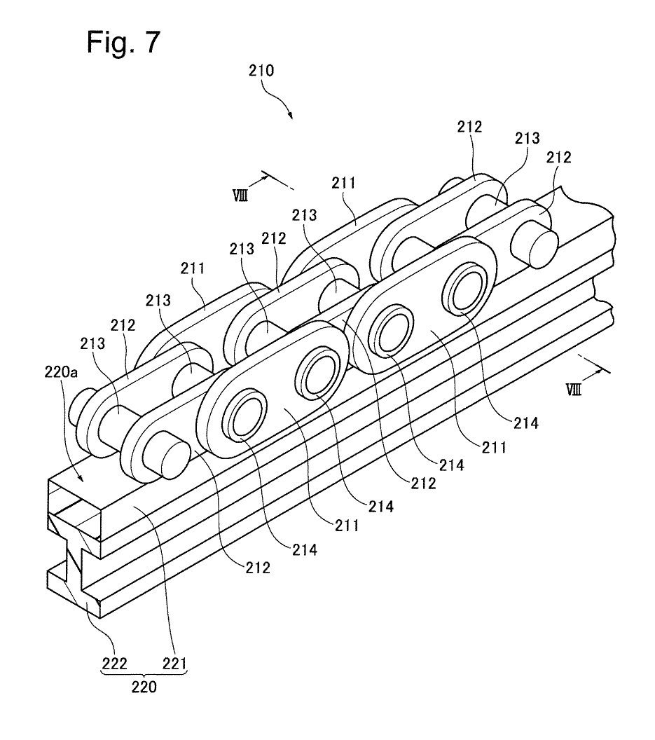

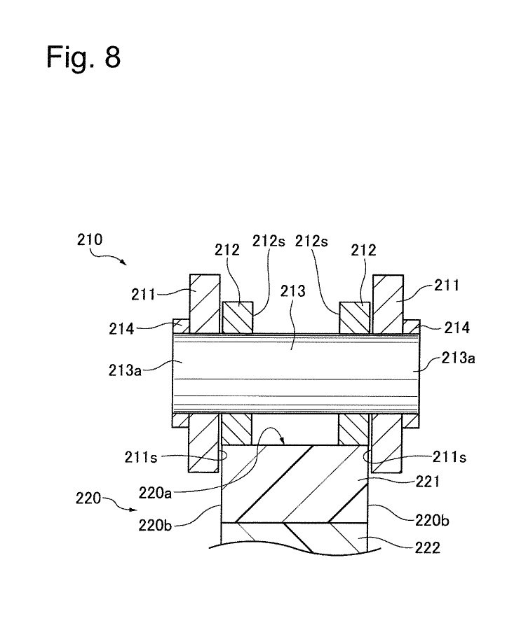

FIGS. 7 and 8 show a modified chain transmission 200, in which parts are designated by reference numbers that exceed by one hundred the reference numbers of corresponding parts in the previously described embodiment. In this chain transmission, outer plates stop rings 214 are press-fit onto end portions 213a of the connecting pins 213. The connecting pins are rotatable in the holes in the outer plates through which they extend. However, the stop rings 214 hold the outer plates 211 against the inner plates 212, and prevent the outer plates 211 from sliding off the ends of the connecting pins.

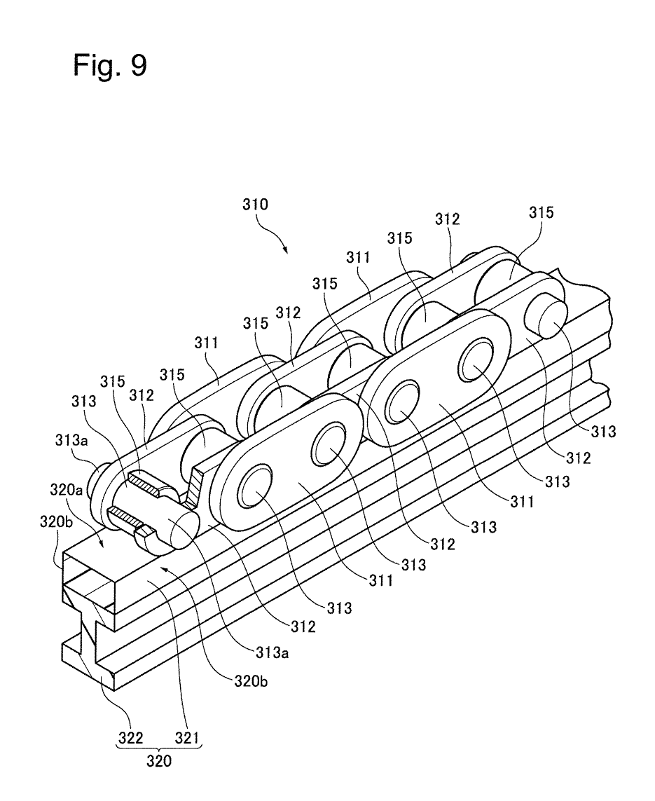

In a modification shown in FIG. 9, parts are designated by reference numbers that exceed by two hundred the reference numbers of corresponding parts in the first-described embodiment. In the chain transmission 300, a chain 310 has rollers 315 that are rotatably fitted around connecting pins 313. These rollers are engageable with the teeth of driving and driven sprockets S1 and S2 in FIG. 1. The rollers 315 receive impact from the sprocket teeth and improve the durability of the transmission chain

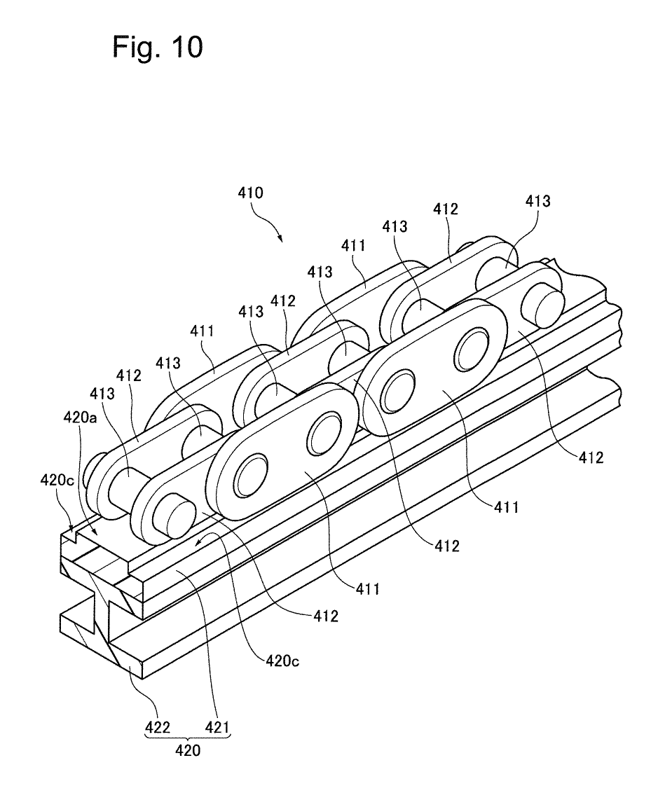

In a second embodiment, shown in FIGS. 10 through 12, parts are designated by reference numbers that exceed by three hundred the reference numbers of corresponding parts in the first-described embodiment. The chain transmission of the second embodiment differs from the chain transmission of the first embodiment primarily in the configuration of the guide.

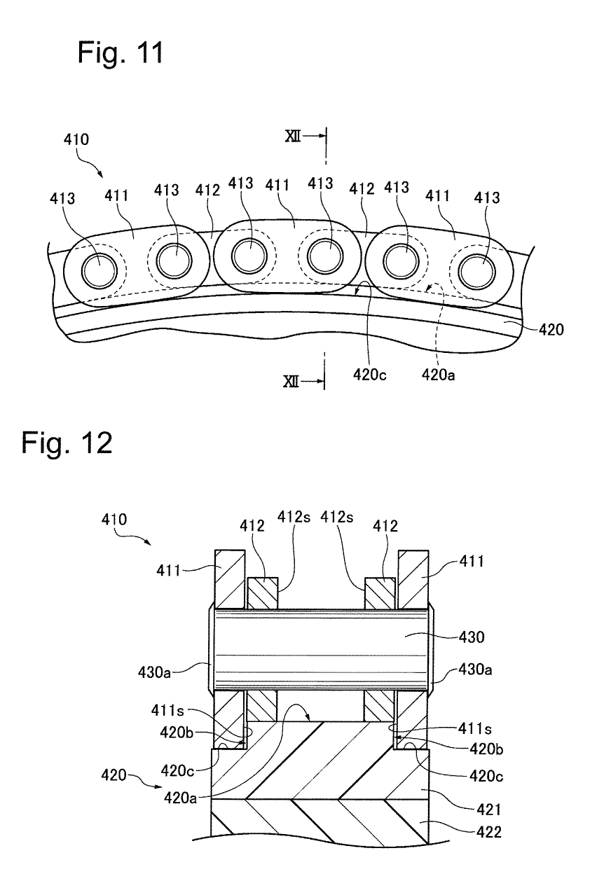

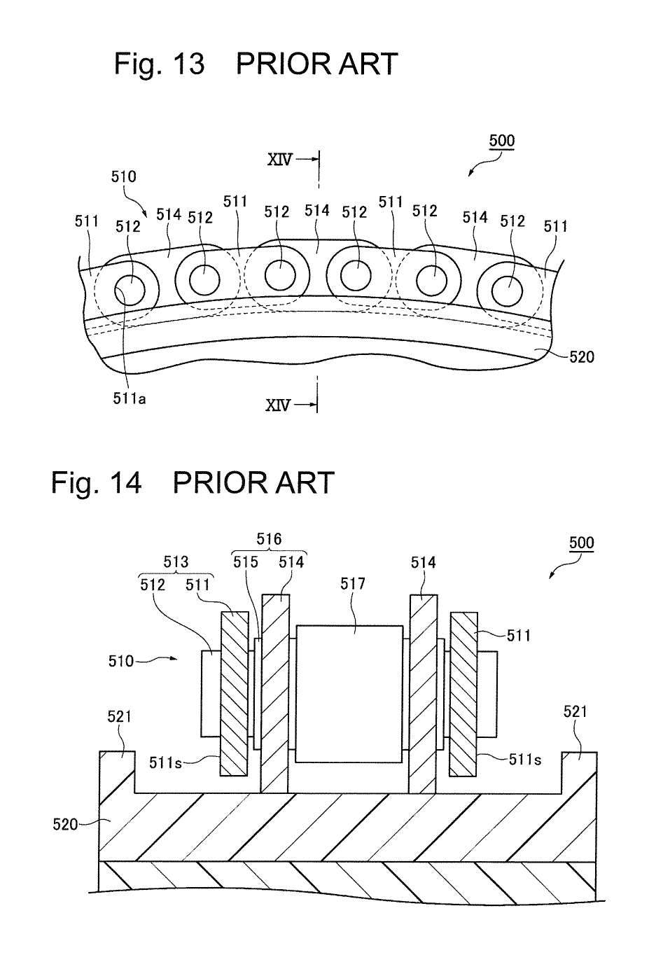

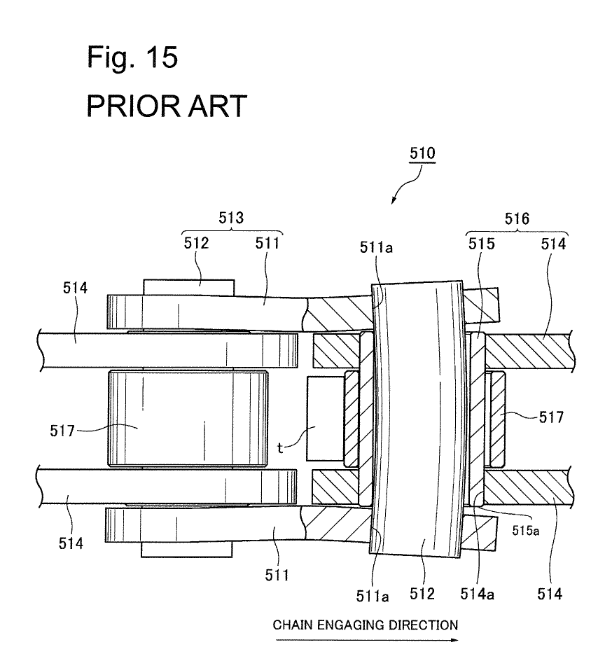

As shown in FIG. 10, guide 420 is formed with surfaces 420c for on which outer plates 411 slide. These surfaces 420c extend parallel to each other in the longitudinal direction of the guide on the both sides of surface 420a on which the inner plates of the chain slide. As shown in FIGS. 11 and 12, the transmission chain 410 travels on the guide 420 with both the inner plates and the outer plates in sliding contact with surfaces of the guide.

In this embodiment, all the advantages of the first-described embodiment are realized. In addition, the greater contact area between the chain and the guide reduces wear of the guide by reducing the surface pressure applied to the guide by the transmission chain.

The second embodiment can be modified in the same ways in which the first embodiment can be modified. That is, the outer plates can be held by caulked end portions of the connecting pins or by stop rings press fit onto the ends of the connecting pins, and the connecting pins can be utilized with or without rollers. Various other modifications can also be made. For example, T-pins extending through end portions of the connecting pins, or stop covering end portions of the connecting pins, can be used in place of caulking or stop rings.

In each case, because the connecting pins are press-fit into pin holes in the inner plates, deflection of the connecting pins is reduced and elongation of the chain caused by the deflection of the connecting pins is suppressed for a long time. In addition, the press-fit relationship of the connecting pins and the inner plates makes assembly of the transmission easier, enables the chain to transmit power more efficiently, reduces the space required for the chain and the chain guides and more effectively prevents the chain from meandering and jumping out of the chain guides.

Although a chain structure in which the heights of the inner link plates are smaller than the heights of the outer link plates is preferable because it allows the chain guide to be downsized and enables the magnitude of sliding-contact sounds to be reduced, other advantages of the invention, e.g., reduced deflection of the connecting pins, can be realized in embodiments in which the heights of the inner plates are greater than the heights of the outer plates and in which the chain guides have inwardly facing sidewalls for guiding the chain. Advantages of the invention can be realized in embodiments in which the chain guide is in sliding contact only with the inner plates of the chain, or only with the outer plates of the chain.

The chain guide structure described herein can be utilized in the movable guide or guides of the chain transmission, in the stationary guide or guides, or in both types of guides in a chain transmission.

What is claimed is:

1. A chain transmission, comprising:
a chain guide; and
an elongated transmission chain in sliding engagement with the chain guide and arranged to travel along the chain guide in the direction of elongation of the chain;
the transmission chain being composed of:
pairs of right and left outer plates, the plates of each pair of outer plates being in opposed, spaced relation to each other in a chain width direction perpendicular to the direction of elongation of the chain, and pairs of right and left inner plates, the plates of each pair of inner plates also being in opposed, spaced relation to each other in said chain width direction, the pairs of inner plates and the pairs of outer plates being disposed in alternating, overlapping, relationship along the length of the chain, each pair of inner plates extending in a first direction into a space between one pair of said outer plates and in a second direction opposite to said first direction into a space between another pair of said outer plates, the plates of each pair of outer plates having mutually facing inner surfaces; and
connecting pins that connect the alternating pairs of said plates in articulating relationship;
wherein each of said connecting pins is press-fit into holes in a pair of said inner plates and fits rotatably in holes in a pair of said outer plates.

2. The chain transmission according to claim 1, wherein the height of the inner plates, measured in a height direction mutually perpendicular to the direction of chain elongation and the chain width direction, is less than the height of said outer plates, also measured in said height direction; wherein the chain guide includes an inner plate-engaging surface, facing in the chain height direction, and in sliding engagement with edges of inner plates of the chain, and outer-plate engaging surfaces, facing in the chain width direction, and in facing relationship with inner surfaces of outer plates of the chain, for restricting lateral travel of the chain.

3. The chain transmission according to claim 2, wherein the chain guide also comprises a pair of outer plate engaging surfaces facing in the chain height direction and in sliding engagement with edges of outer plates of the chain.

4. The chain transmission according to claim 1, wherein the outer plates are held on the connecting pins by caulked end portions of the connecting pins.

5. The chain transmission according to claim 1, wherein the outer plates are held on the connecting pins by stop rings press-fit onto end portions of the connecting pins.
